(19) United States
(12) Patent Application Publication
(10) Pub. No.: US 2018/0192458 A1
(43) Pub. Date: Jul. 5, 2018

(54) RADIO TERMINAL, D2D COMMUNICATION CONTROL APPARATUS, BASE STATION, PRELIMINARY RELAY RADIO TERMINAL SELECTION METHOD, NON-TRANSITORY COMPUTER READABLE MEDIUM

(71) Applicant: NEC CORPORATION, Tokyo (JP)

(72) Inventors: Hiroaki AMINAKA, Tokyo (JP); Kazushi MURAOKA, Tokyo (JP); Taichi OHTSUJI, Tokyo (JP)

(73) Assignee: NEC CORPORATION, Tokyo (JP)

(21) Appl. No.: 15/739,407

(22) PCT Filed: Jan. 19, 2016
(86) PCT No.: PCT/JP2016/000235

§ 371 Date: Dec. 22, 2017

(30) Foreign Application Priority Data
Jun. 25, 2015 (JP) 2015-127782

(51) Int. Cl. H04W 76/14; H04W 88/04; H04W 76/23; H04W 8/00; H04W 36/30

(52) U.S. Cl. CPC H04W 76/14; H04W 88/04; H04W 92/18; H04W 8/005; H04W 36/30; H04W 76/23

(57) ABSTRACT

A D2D communication control apparatus (10) according to the present invention includes: a communication unit (11) configured to receive determination information that can be used to determine whether a plurality of radio terminals are capable of performing direct communication with another radio terminal; and a selection unit (12) configured to select, in a situation in which a first radio terminal included in the plurality of radio terminals is performing D2D communication with a relay radio terminal that performs cellular communication with a network, a radio terminal in which the determination information between the radio terminal and the relay radio terminal satisfies a predetermined condition among radio terminals capable of performing D2D communication with the first radio terminal, as a preliminary relay radio terminal.

### TECHNICAL FIELD

The present invention relates to a radio terminal, a D2D communication control apparatus, a base station, a preliminary relay radio terminal selection method, and a program, and relates, for example, to a D2D communication control apparatus, a radio terminal, a preliminary relay radio terminal selection method, and a program for configuring a preliminary communication line.

### BACKGROUND ART

In mobile communication systems, introduction of device-to-device (D2D) communication, in which a radio terminal directly communicates with another radio terminal, has been discussed. For example, 3rd Generation Partnership Project (3GPP), which defines standard specifications of mobile communication systems, specifies Proximity-based services (ProSe) as the D2D communication in Non-Patent Literature 1. ProSe includes ProSe discovery and ProSe direct communication. ProSe discovery makes it possible to detect proximity of radio terminals. ProSe direct communication enables establishment of a communication path between radio terminals discovered by the ProSe discovery.

Patent Literature 1 discloses a discovery procedure between radio terminals that perform D2D communication. Specifically, a User Equipment (UE) 100-1 transmits a discovery signal by broadcasting and a UE 100-2 performs processing for receiving the discovery signal that has been transmitted. The UE 100-2 performs processing for receiving the discovery signal, to thereby discover the UE 100-1 that has transmitted the discovery signal. Further, the UE 100-2 transmits a response signal to the UE 100-1, whereby the UE 100-1 is able to determine that it has been discovered by the UE 100-2. The UE 100-2 determines in advance regarding whether it is capable of performing D2D communication with the UE 100-1 based on the distance between the UE 100-2 and the UE 100-1. Therefore, the UE 100-2 is able to perform processing for receiving the discovery signal that has been transmitted from the predetermined UE in advance.

### CITATION LIST

### Patent Literature

[Patent Literature 1] International Patent Publication No. WO 2015/045860

### Non-Patent Literature

[Non-Patent Literature 1] 3GPP TS 23.303 V12.4.0 (March 2015), “3rd Generation Partnership Project; Technical Specification Group Services and System Aspects; Proximity-based services (ProSe); Stage 2 (Release 12)”, March, 2015

### SUMMARY OF INVENTION

### Technical Problem

A case in which D2D communication is performed in an environment such as an indoor environment in which the radio quality dramatically changes will be explained. Specifically, assume a case in which a radio terminal performs D2D communication with a relay terminal and performs communication with a network via the relay terminal. In this environment, when a user who holds the radio terminal or a user who holds the relay terminal moves, the radio line that has been configured to establish D2D communication between the radio terminal and the relay terminal may be disconnected and the D2D communication may thus not be continued.

In order to deal with the aforementioned case, the radio terminal may configure a backup line with another relay terminal in advance. When there are a plurality of relay terminals in the vicinity of a radio terminal, however, a problem that the relay terminal that has been selected may not be able to appropriately serve as the backup line occurs. When, for example, a radio terminal that behaves in a way similar to the way the relay terminal that is currently performing D2D communication behaves, a radio terminal that is located in the same place as the relay terminal or the like is selected as the terminal in which the backup line should be configured, it is highly likely that the backup line is also disconnected at the timing the same as the timing when the radio line currently configured to perform D2D communication is disconnected.

One of the objects to be attained by the present invention is to provide a radio terminal, a D2D communication control apparatus, a base station, a preliminary relay radio terminal selection method, and a program capable of configuring an appropriate backup line in case that a radio line that is performing D2D communication is disconnected.

### Solution to Problem

A radio terminal according to a first aspect of the present invention includes: a communication unit configured to receive determination information that can be used to determine whether each of a plurality of other radio terminals is capable of performing device-to-device (D2D) communication with another radio terminal; and a selection unit configured to select, in a situation in which D2D communication is being performed with a relay radio terminal that performs cellular communication with a network, a radio terminal in which the determination information between the radio terminal and the relay radio terminal satisfies a predetermined condition among radio terminals that are capable of performing D2D communication, as a preliminary relay radio terminal.

A D2D communication control apparatus according to a second aspect of the present invention includes: a communication unit configured to receive determination information that can be used to determine whether a plurality of radio terminals are capable of performing direct communication (device-to-device (D2D) communication) with another radio terminal; and a selection unit configured to select, in a situation in which a first radio terminal included in the plurality of radio terminals is performing D2D communication with a relay radio terminal that performs cellular communication with a network, a radio terminal in which the determination information between the radio terminal and the relay radio terminal satisfies a predetermined condition among radio terminals capable of performing D2D communication with the first radio terminal, as a preliminary relay radio terminal.

A base station according to a third aspect of the present invention includes: a communication unit configured to receive determination information that can be used to determine whether a plurality of radio terminals are capable of performing device-to-device (D2D) communication with another radio terminal; and a selection unit configured to select, in a situation in which a first radio terminal included in the plurality of radio terminals is performing D2D communication with a relay radio terminal that performs cellular communication with a network, a radio terminal in which the determination information between the radio terminal and the relay radio terminal satisfies a predetermined condition among radio terminals capable of performing D2D communication with the first radio terminal, as a preliminary relay radio terminal.

A preliminary relay radio terminal selection method according to a fourth aspect of the present invention includes: receiving determination information that can be used to determine whether a plurality of radio terminals are capable of performing device-to-device (D2D) communication with another terminal; and selecting, in a situation in which a first radio terminal included in the plurality of radio terminals is performing D2D communication with a relay radio terminal that performs cellular communication with a network, a radio terminal in which the determination information between the radio terminal and the relay radio terminal satisfies a predetermined condition among radio terminals capable of performing D2D communication with the first radio terminal, as a preliminary relay radio terminal.

A program according to a fifth aspect of the present invention causes a computer to execute the following processing of: receiving determination information that can be used to determine whether a plurality of radio terminals are capable of performing device-to-device (D2D) communication with another terminal; and selecting, in a situation in which a first radio terminal included in the plurality of radio terminals is performing D2D communication with a relay radio terminal that performs cellular communication with a network, a radio terminal in which the determination information between the radio terminal and the relay radio terminal satisfies a predetermined condition among radio terminals capable of performing D2D communication with the first radio terminal, as a preliminary relay radio terminal.

### Advantageous Effects of Invention

According to the present invention, it is possible to provide a radio terminal, a D2D communication control apparatus, a base station, a preliminary relay radio terminal selection method, and a program capable of configuring an appropriate backup line in case that a radio line that is performing D2D communication is disconnected.

### BRIEF DESCRIPTION OF DRAWINGS

FIG. 1 is a configuration diagram of a radio terminal according to a first embodiment;

FIG. 2 is a configuration diagram of a mobile communication system according to a second embodiment;

FIG. 3 is a configuration diagram of the mobile communication system according to the second embodiment;

FIG. 4 is a configuration diagram of a radio terminal according to the second embodiment;

FIG. 5 is a diagram showing a flow of processing of selecting a preliminary relay radio terminal in the radio terminal according to the second embodiment;

FIG. 6 is a diagram showing distances between radio terminals according to the second embodiment;

FIG. 7 is a diagram showing results of receiving a discovery signal transmitted between radio terminals according to the second embodiment;

FIG. 8 is a diagram showing a flow of processing of transmitting determination information in the radio terminal according to the second embodiment;

FIG. 9 is a diagram showing a flow of processing when the radio terminal has received a preliminary relay terminal indication according to the second embodiment;

FIG. 10 is a diagram showing a flow of processing of the radio terminal when it has received a preliminary relay terminal request according to the second embodiment;

FIG. 11 is a diagram showing a sequence of processing of selecting the preliminary relay radio terminal according to the second embodiment;

FIG. 12 is a configuration diagram of a D2D communication control apparatus according to a third embodiment;

FIG. 13 is a diagram showing a result of receiving a discovery signal transmitted between radio terminals according to the third embodiment;

FIG. 14 is a diagram showing a sequence of processing of selecting a preliminary relay radio terminal according to the third embodiment;

FIG. 15 is a configuration diagram of a base station according to a fourth embodiment;

FIG. 16 is a block diagram showing a configuration example of a radio terminal according to several embodiments;

FIG. 17 is a block diagram showing a configuration example of a base station according to several embodiments; and

FIG. 18 is a block diagram showing a configuration example of a D2D communication control apparatus according to several embodiments.

### DESCRIPTION OF EMBODIMENTS

### First Embodiment

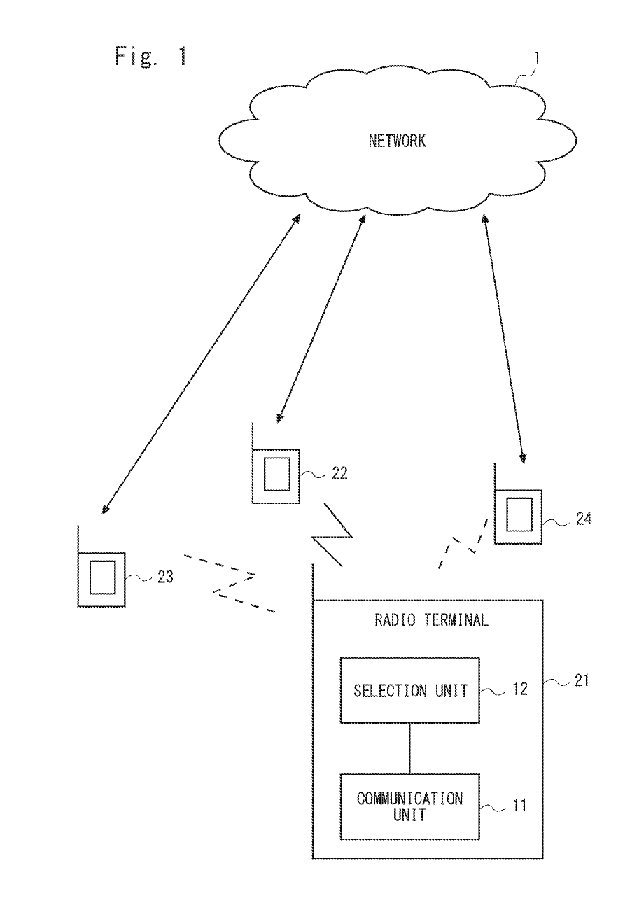

Specific embodiments of the present invention will be explained hereinafter with reference to the drawings. First, with reference to FIG. 1, a configuration example of a radio terminal 21 according to a first embodiment of the present invention will be explained. The radio terminal 21 may be a computer apparatus that is operated by a processor executing a program stored in a memory.

The radio terminal 21 includes a communication unit 11 and a selection unit 12. Each of the communication unit 11 and the selection unit 12 may be a software, a module or the like whose processing is executed by a processor executing a program stored in a memory. Alternatively, each of the communication unit 11 and the selection unit 12 may be a hardware such as a circuit or a chip.

The communication unit 11 receives determination information that can be used to determine whether each of radio terminals 22-24 is capable of performing D2D communication with another radio terminal. The other radio terminal may be, for example, one of nearby radio terminals of the radio terminals 22-24.

The radio terminals 21-24 may be, for example, a mobile telephone terminal, a smartphone terminal, or a Machine Type Communication (MTC) terminal that autonomously performs communication without requiring user manipulation. The radio terminal may also be referred to as a User Equipment (UE), which is a general term for radio terminals defined by the 3GPP. The D2D communication may be, for example, ProSe discovery and ProSe direct communication.

The determination information that can be used to determine whether the D2D communication can be performed with another radio terminal may be, for example, positional information generated by each of the radio terminals 21-24. The positional information may be, for example, GNSS positional information obtained by a Global Navigation Satellite System (GNSS) receiver. The radio terminal 21 or the D2D communication control apparatus that controls the D2D communication may calculate the distance between radio terminals using, for example, the positional information on the radio terminals. The radio terminal 21 or the D2D communication control apparatus may determine that the radio terminals are capable of performing D2D communication when the calculated distance is shorter than a predetermined distance.

Further, the determination information may be information on a result of receiving a discovery signal that each of the radio terminals 21-24 has received from another radio terminal. The discovery signal may be referred to as, for example, a Discovery signal or a discovery message. The radio terminal 21 or the D2D communication control apparatus may determine that the radio terminal that has received the discovery signal and the radio terminal that has transmitted the discovery signal are capable of performing D2D communication.

Each of the radio terminals 21-24 is capable of performing D2D communication with another radio terminal. Further, each of the radio terminals 21-24 is capable of performing cellular communication with a network 1. Accordingly, each of the radio terminals 21-24 is able to serve as a relay radio terminal that relays communication between another radio terminal and the network 1.

The selection unit 12 selects, as a preliminary relay radio terminal, in a state in which the radio terminal 21 is performing D2D communication with the radio terminal 22, which is the relay radio terminal, a radio terminal in which the determination information between the radio terminal 21 and the radio terminal 22, which is the relay radio terminal, satisfies a predetermined condition among radio terminals capable of performing D2D communication with the radio terminal 21. That is, the selection unit 12 selects the preliminary relay radio terminal of the radio terminal 21 using the determination information between the relay radio terminal that the radio terminal 21 is currently performing D2D communication and the radio terminal that may operate as the relay radio terminal.

The relay radio terminal performs cellular communication with the network 1 using, for example, the cellular communication technology (e.g., Evolved Universal Terrestrial Radio Access (E-UTRA) technology). Further, while the radio terminal actually communicates with the network 1 via one relay radio terminal, one or more preliminary relay radio terminals may be selected. The radio terminal may configure a radio line for performing D2D communication with the preliminary relay radio terminal while it is performing D2D communication with the relay radio terminal. The radio terminal switches the communication partner with which it performs D2D communication to the preliminary relay radio terminal when it is no longer possible to maintain the D2D communication between the radio terminal and the relay radio terminal; that is, when the radio line between the radio terminal and the relay radio terminal has been disconnected. In another case, the radio terminal may switch the communication partner with which it performs D2D communication to the preliminary relay radio terminal when it is estimated that it will not be able to maintain the D2D communication between the radio terminal and the relay radio terminal.

The predetermined condition that the determination information between the preliminary relay radio terminal and the relay radio terminal should satisfy may be a condition regarding the position of the preliminary relay radio terminal with respect to the relay radio terminal or may be a condition regarding a result of receiving the discovery signal between the preliminary relay radio terminal and the relay radio terminal.

As described above, the radio terminal 21 shown in FIG. 1 is able to select the preliminary relay radio terminal. Specifically, the radio terminal 21 is able to select the preliminary relay radio terminal using the determination information between the radio terminal capable of performing D2D communication and the radio terminal 22, which is the relay radio terminal. Accordingly, the radio terminal 21 is able to select the preliminary relay radio terminal in accordance with the positional relation between the relay radio terminal that is currently performing D2D communication and another radio terminal or the result of receiving the discovery signal between the relay radio terminal and another radio terminal. The radio terminal 21 is able to select, for example, a radio terminal whose correlation in the positional relation with the relay radio terminal is low as the preliminary relay radio terminal.

That the above correlation is low may mean, for example, that the relay radio terminal and the preliminary relay radio terminal are located sufficiently away from each other and they have radio environments different from each other or that the relay radio terminal and the preliminary relay radio terminal are located away from each other so that they cannot perform D2D communication with each other. More specifically, that the correlation is low may mean that the cause of disconnection of the D2D communication between the radio terminal 21 and the relay radio terminal does not have any influence on a backup line or has little influence on the backup line. That the above cause of disconnection has little influence on the backup line may mean, for example, that this cause does not have enough influence on the backup line to lead to disconnection of the backup line.

Accordingly, the radio terminal 21 is able to select the preliminary relay radio terminal in which it is possible to configure the backup line little affected by the cause of the disconnection of the D2D communication when the D2D communication between the radio terminal 21 and the relay radio terminal is disconnected. Accordingly, even when the D2D communication between the radio terminal 21 and the relay radio terminal has been disconnected, the radio terminal 21 is able to continuously perform D2D communication using the backup line.

### Second Embodiment

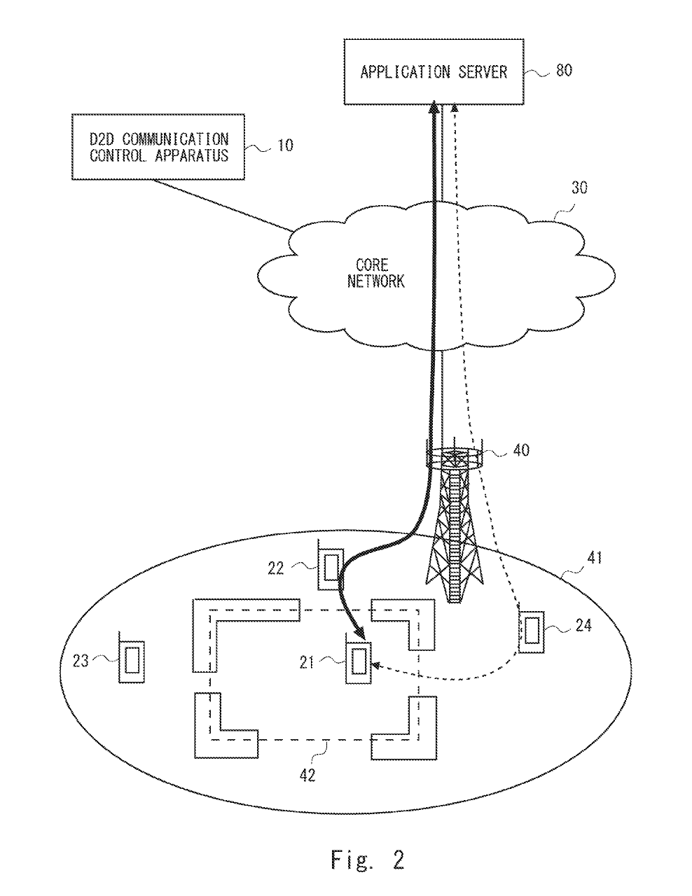

With reference next to FIG. 2, a configuration example of a mobile communication system according to a second embodiment of the present invention will be explained. The mobile communication system shown in FIG. 2 includes a D2D communication control apparatus 10, radio terminals 21-24, a core network 30, a base station 40, and an application server 80.

Since the radio terminals 21-24 are similar to the radio terminals 21-24 shown in FIG. 1, detailed descriptions thereof will be omitted.

Alternatively, the D2D communication control apparatus 10 may be an apparatus that executes a ProSe function. The ProSe function is a logical function that is used for public land mobile network (PLMN)-related operations required for ProSe. The functionality provided by the ProSe function includes, for example: (a) communication with third-party applications (a ProSe Application Server); (b) authentication of a radio terminal (UE) for ProSe discovery and ProSe direct communication; (c) transmission of configuration information for ProSe discovery and ProSe direct communication (e.g., EPC-ProSe-User ID) to a UE; and (d) provision of network-level discovery (i.e., EPC-level ProSe discovery).

In EPC-level ProSe discovery, the D2D communication control apparatus 10 or a core network (Evolved Packet Core (EPC)) determines proximity of two radio terminals and notifies the two radio terminals of the result of the determination.

The apparatus that executes the ProSe function may be referred to as, for example, a ProSe function entity or a ProSe function server.

The core network 30 may be, for example, an EPC, and includes a plurality of user-plane entities and a plurality of control-plane entities. The user-plane entity may be, for example, Serving Gateway (S-GW) and Packet Data Network Gateway (P-GW). Further, the control-plane entity may be Mobility Management Entity (MME) and Home Subscriber Server (HSS). Each of the user-plane entity and the control-plane entity may be referred to as a core network apparatus. Further, the core network 30 may include a ProSe function entity, a ProSe function server or the like. Further, the user-plane entity or the control-plane entity may execute the ProSe function as the ProSe function entity.

The plurality of user-plane entities relay user data of the radio terminals 21-24 between the radio access network including the base station 40 and an external network. The plurality of control-plane entities perform various kinds of control for the radio terminals 21-24 including mobility management, session management (bearer management), subscriber information management, and billing management.

The base station 40 forms a cell 41. The cell 41 is an area where radio terminals are capable of performing cellular communication with the base station 40. Further, a coverage hole 42 is an area in the cell 41 and is an area in which radio terminals cannot perform cellular communication with the base station 40 or an area in which a desired cellular communication (whose communication rate is equal to or larger than a predetermined value) cannot be performed. For example, the coverage hole 42 is generated in a building located in the cell 41, an area surrounded by a plurality of buildings and the like. The base station 40 may be, for example, an evolved NodeB (eNB) defined by the 3GPP. FIG. 2 shows that the radio terminal 21 located in the coverage hole 42 performs D2D communication with the relay radio terminal from a gap between the buildings that surround the coverage hole 42.

FIG. 2 shows an example in which the radio terminal 22 is the relay radio terminal. Further, FIG. 2 shows an example in which the radio terminal 24 is the preliminary relay radio terminal. The solid arrow shown in FIG. 2 shows that the radio terminal 21 performs communication with the application server 80 via the radio terminal 22, which is the relay radio terminal, the base station 40, and the core network 30. The broken arrow shown in FIG. 2 shows that the radio terminal 21 configures the preliminary communication line with the application server 80 via the radio terminal 24, which is the preliminary relay radio terminal, the base station 40, and the core network 30.

The radio terminal 21 is located in the coverage hole 42 and communicates with the base station 40 via the radio terminal 22, which is the relay radio terminal. The radio terminal 21 performs D2D communication with the radio terminal 22. Further, the radio terminal 21 configures the radio line with the radio terminal 24, which is the preliminary relay radio terminal, in case of the radio line between the radio terminal 21 and the radio terminal 22 being disconnected. The communication line that the radio terminal 21 configures between the radio terminal 21 and the application server 80 via the radio terminal 22, the base station 40, and the core network 30 is referred to as the main line and the preliminary communication line that the radio terminal 21 configures between the radio terminal 21 and the application server 80 via the radio terminal 24, the base station 40, and the core network 30 may be referred to as the backup line.

The radio terminal 21 switches the main line to the backup line when the radio terminal 21 estimates that it will not be able to perform D2D communication with the radio terminal 22 any longer or it will not be able to perform a desired D2D communication with the radio terminal 22. The radio terminal 21 may periodically measure, for example, Reference Signal Received Power (RSRP) or Reference Signal Received Quality (RSRQ) and may estimate that it will not be able to communicate with the radio terminal 22 when the communication quality indicated by the RSRP or the RSRQ is lower than a predetermined communication quality. In other words, the radio terminal 21 may determine the timing when the main line is switched to the backup line based on the value of the RSRP or the RSRQ. Further, the index for measuring, by the radio terminal 21, the communication quality is not limited to RSRP or RSRQ. Alternatively, the radio terminal 21 may periodically measure the communication rate (throughput) of the data transmitted to and received from the radio terminal 22 and estimate that it will not be able to perform a desired D2D communication with the radio terminal 22 when the value of the communication rate that has been measured is below a predetermined value.

While FIG. 2 shows a state in which the radio terminals 21-24 are located in the cell 41, some of the radio terminals 21-24 may be located in a cell formed by another base station. Further, when the relay radio terminal and the preliminary relay radio terminal are located in cells different from each other, the base station that is used in the communication using the main line may be different from the base station that is used in the communication using the backup line.

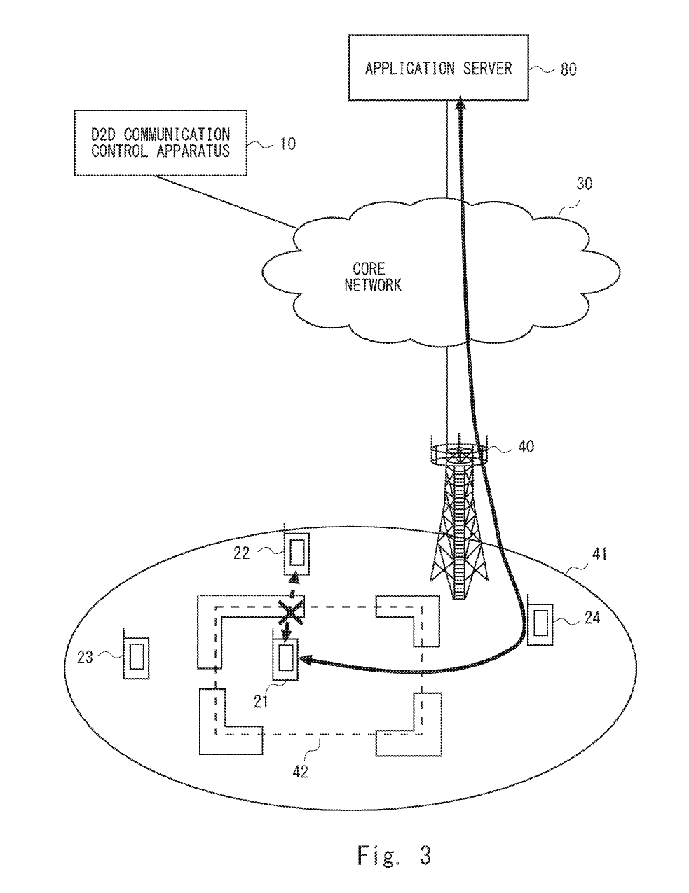

FIG. 3 shows a state in which the radio terminal 21 has switched the main line to the backup line since the radio terminal 21 cannot perform D2D communication with the radio terminal 22 any longer. FIG. 3 shows a state in which since the radio terminal 21 moves in the coverage hole 42 or the radio terminal 22 makes a movement, a shielding object exists between the radio terminal 21 and the radio terminal 22, which results in a situation in which the radio terminal 21 cannot perform D2D communication with the radio terminal 22 any longer.

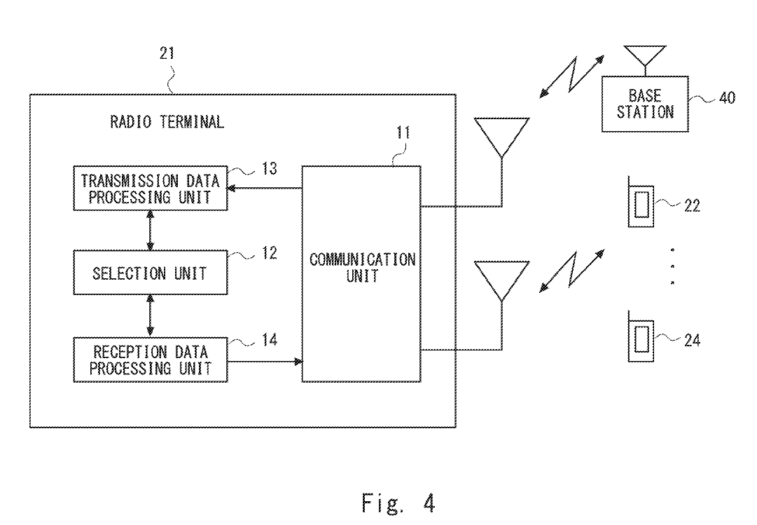

With reference next to FIG. 4, a configuration example of the radio terminal 21 according to the second embodiment of the present invention will be explained. The radio terminal 21 includes the communication unit 11, the selection unit 12, the transmission data processing unit 13, and the reception data processing unit 14. Since the communication unit 11 and the selection unit 12 are similar to the communication unit 11 and the selection unit 12 shown in FIG. 1, detailed descriptions thereof will be omitted.

The communication unit 11 communicates with the base station 40 by radio and performs D2D communication with the nearby radio terminals 22-24 etc.

The reception data processing unit 14 may receive the determination information from another radio terminal via the communication unit 11 that performs D2D communication. Alternatively, the reception data processing unit 14 may receive the determination information from another radio terminal via the communication unit 11 that performs cellular communication and the base station 40. The reception data processing unit 14 outputs the determination information that has been received to the selection unit 12.

The selection unit 12 selects the preliminary relay radio terminal of the radio terminal 21 using the determination information. The selection unit 12 outputs information regarding the preliminary relay radio terminal that has been selected to the transmission data processing unit 13.

The transmission data processing unit 13 transmits an indication signal to another radio terminal via the communication unit 11. The indication signal may be transmitted to another radio terminal by performing D2D communication or may be transmitted to another radio terminal via the base station 40. The indication signal is used to notify the radio terminal that has been selected by the selection unit 12 that it is the preliminary relay radio terminal. In the following description, the indication signal is assumed to be a preliminary relay terminal indication. The transmission data processing unit 13 may set, as the destination of the preliminary relay terminal indication, address information on the radio terminal selected by the selection unit 12 to be the preliminary relay radio terminal. The preliminary relay terminal indication may be generated in the selection unit 12 or may be generated in the transmission data processing unit 13.

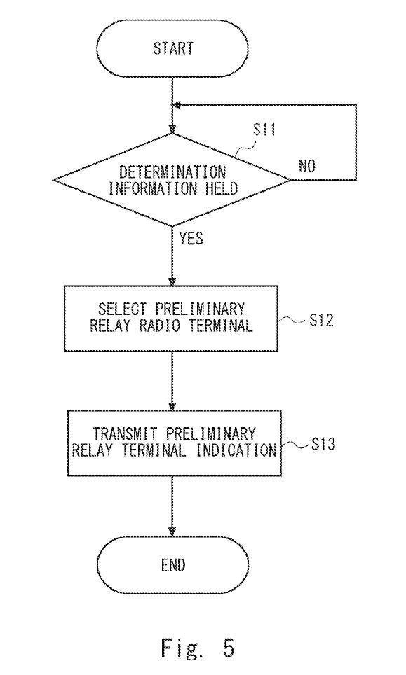

With reference next to FIG. 5, a flow of processing for selecting the preliminary relay radio terminal in the radio terminal 21 according to the second embodiment of the present invention will be explained. First, the selection unit 12 determines whether it holds the determination information (S11). Upon receiving the determination information output from the reception data processing unit 14, the selection unit 12 may store or record the determination information in a memory or the like in the radio terminal 21.

The selection unit 12 repeats the processing of Step S11 when it is determined that it does not hold the determination information. Alternatively, the selection unit 12 may transmit a determination information request for requesting transmission of the determination information to each of the radio terminals when it is determined that it does not hold the determination information.

The selection unit 12 selects, when it is determined that it holds the determination information, the preliminary relay radio terminal using the determination information (S12). Next, the transmission data processing unit 13 transmits the preliminary relay terminal indication to the preliminary relay radio terminal that has been selected by the selection unit 12 (S13).

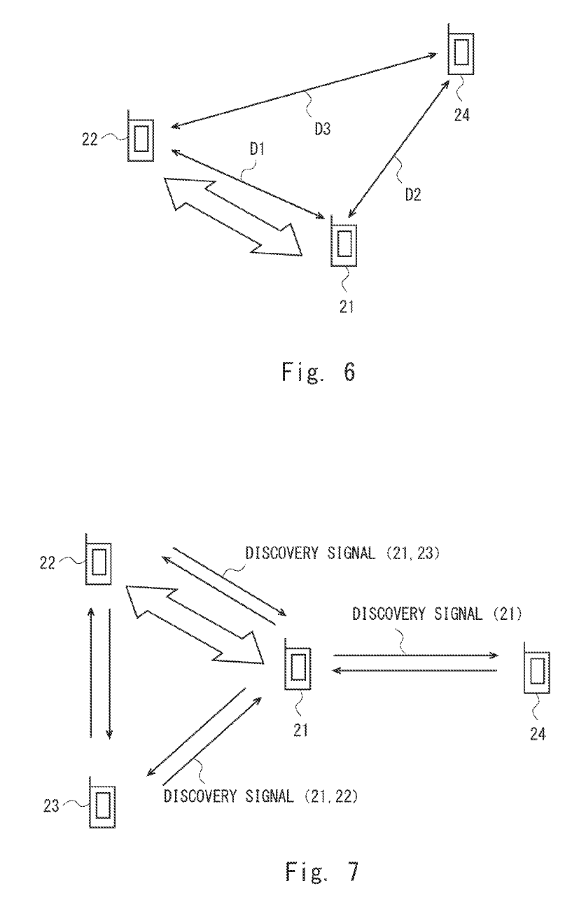

Now, details of the processing for selecting the preliminary relay radio terminal of the radio terminal 21 in Step S12 will be explained. With reference first to FIG. 6, a case in which the radio terminal 21 has received the positional information on each of the radio terminals as the determination information will be explained. The selection unit 12 calculates a distance D1 between the radio terminal 21, which is an own device, and the radio terminal 22, which is the relay radio terminal. Further, the selection unit 12 calculates a distance D2 between the radio terminal 21 and the radio terminal 24. Further, the selection unit 12 calculates a distance D3 between the radio terminal 22 and the radio terminal 24.

The selection unit 12 selects the radio terminal 24 that satisfies D3≥D1 and D3≥D2 as the preliminary relay radio terminal. D2 is a distance equal to or smaller than the longest distance in which D2D communication with the radio terminal 21 can be performed. The selection unit 12 selects the preliminary relay radio terminal as described above, to thereby able to select, as the preliminary relay radio terminal of the radio terminal 21, the radio terminal 24 which is located in a direction different from that of the radio terminal 22 that is currently operating as the relay radio terminal with respect to the radio terminal 21. That the terminals are located in directions different from each other may mean, for example, that the radio terminal 22 and the radio terminal 24 are located in directions different from each other with respect to the radio terminal 21. Alternatively, that the terminals are located in directions different from each other may mean, for example, that, the radio terminals are located in such a way as to satisfy a condition that the angle of the vertex formed in the radio terminal 21 when the radio terminal 21 and the radio terminal 22 are connected to each other by a line and the radio terminal 21 and the radio terminal 24 are connected to each other by a line is equal to or larger than a predetermined angle. Accordingly, the selection unit 12 may select the radio terminal 24 having a radio environment different from the radio environment in the radio terminal 22 as the preliminary relay radio terminal of the radio terminal 21.

By selecting, by the selection unit 12, the radio terminal having a radio environment different from that of the relay radio terminal with which the radio terminal 21 is currently performing D2D communication as the preliminary relay radio terminal, it is possible to reduce the probability that both the main line and the backup line cannot be used.

Further, the selection unit 12 is able to select a plurality of preliminary relay radio terminals by determining whether the radio terminals other than the radio terminal 24 also satisfy D3≥D1 and D3≥D2.

With reference next to FIG. 7, a case in which the radio terminal 21 has received the information on the result of receiving the discovery signal in each of the radio terminals as the determination information will be explained. It is assumed in FIG. 7 that the radio terminal 21 uses the radio terminal 22 as the relay radio terminal and each of the radio terminal 21, the radio terminal 22, the radio terminal 23, and the radio terminal 24 transmits and receives the discovery signal to and from a nearby radio terminal.

The information on the result of receiving the discovery signal in each radio terminal may be, for example, information including identification information on a transmission source radio terminal indicated in the discovery signal that has been received. The identification information may be a UE ID or may be address information such as a Media Access Control (MAC) address. For example, since the radio terminal 21 receives the discovery signal from the radio terminal 22, the radio terminal 23, and the radio terminal 24, the result of receiving the discovery signal is (22, 23, 24). The numerals 22, 23, and 24 are attached to the radio terminals, and indicate the identification information on the radio terminals.

Further, the result of the reception in the radio terminal 22 is (21, 23), the result of the reception in the radio terminal 23 is (21, 22), and the result of the reception in the radio terminal 24 is (21). Each of the radio terminals transmits the result of the reception to the radio terminal 21.

The radio terminal 21 first extracts, when it selects the preliminary relay radio terminal, a radio terminal including the identification information on the radio terminal 21 as the result of the reception. In this example, the radio terminal 21 extracts the radio terminal 22, the radio terminal 23, and the radio terminal 24. The radio terminal including the identification information on the radio terminal 21 as the result of the reception is a radio terminal that is capable of performing D2D communication with the radio terminal 21.

Next, the radio terminal 21 selects a radio terminal that is not able to transmit or receive the discovery signal to or from the radio terminal 22, which is the relay radio terminal, as the preliminary relay radio terminal. In this example, since the radio terminal 23 includes the identification information on the radio terminal 22 in the result of the reception, the radio terminal 23 is not selected as the preliminary relay radio terminal. The radio terminal 24 does not include the identification information on the radio terminal 22 in the result of the reception. Therefore, the radio terminal 21 selects the radio terminal 24 as the preliminary relay radio terminal. In this way, the radio terminal that is not able to transmit or receive the discovery signal to or from the radio terminal 22, which is the relay radio terminal, may be referred to as the radio terminal whose correlation with the radio terminal 22 is low.

While the procedure for selecting the preliminary relay radio terminal when the identification information on the radio terminal is mainly used has been described in the aforementioned description, the selection unit 12 may select the preliminary relay radio terminal using the reception power of the discovery signal or information regarding the number of times the discovery signal has been received. The reception power of the discovery signal, the information regarding the number of times the discovery signal has been received and the like may be included in the determination information.

When there are a plurality of preliminary relay radio terminals selected using the positional information or the identification information on the radio terminal that has transmitted the discovery signal, the selection unit 12 may further select, for example, the preliminary relay radio terminal using information such as reception power. Alternatively, when it is impossible to select the preliminary relay radio terminal using the positional information or the identification information on the radio terminal that has transmitted the discovery signal, the selection unit 12 may select the preliminary relay radio terminal using information such as reception power.

When there are a plurality of preliminary relay radio terminals, the selection unit 12 may select, for example, a radio terminal that has transmitted the discovery signal whose reception power is larger than a predetermined value or a radio terminal that has transmitted the discovery signal whose reception power is the largest as the preliminary relay radio terminal. In this case, it is possible to maintain a high communication quality between the radio terminal 21 and the preliminary relay radio terminal.

Alternatively, the selection unit 12 may select, when there is no preliminary relay radio terminal, a radio terminal in which the reception power of the discovery signal transmitted from the radio terminal 22 is smaller than a predetermined value or a radio terminal whose reception power is the smallest as the preliminary relay radio terminal. In this case, the selection unit 12 is able to select a radio terminal that is located away from the radio terminal 22, which is the relay radio terminal, by a certain distance, as the preliminary relay radio terminal.

Alternatively, the selection unit 12 may select, when there are a plurality of preliminary relay radio terminals, a radio terminal in which the number of times the discovery signal transmitted from each of the radio terminals has been received is larger than a predetermined value or the largest as the preliminary relay radio terminal. In this case, it becomes possible to improve the probability that the D2D communication can be normally executed.

Alternatively, when the preliminary relay radio terminal is not present, the selection unit 12 may select, as the preliminary relay radio terminal, a radio terminal in which the number of times that the discovery signal transmitted from the radio terminal 22 has been received is smaller than a predetermined value or is the smallest. In this case, the selection unit 12 is able to select a radio terminal that is located away from the radio terminal 22, which is the relay radio terminal, by a certain distance, as the preliminary relay radio terminal.

Besides the aforementioned information, when, for example, each of the radio terminals has already operated as the relay radio terminal, the selection unit 12 may select the preliminary relay radio terminal in accordance with the number of radio terminals that are executing D2D communication. For example, the selection unit 12 may select a radio terminal in which the number of radio terminals that are executing D2D communication is smaller than a predetermined value as the preliminary relay radio terminal. It is therefore possible to reduce the processing load of the preliminary relay radio terminal.

Besides the aforementioned information, when, for example, each of the radio terminals has already operated as the preliminary relay radio terminal, the selection unit 12 may select a radio terminal in which the number of radio terminals where the backup line is configured is smaller than a predetermined value as the preliminary relay radio terminal. It is therefore possible to reduce the processing load of the preliminary relay radio terminal.

Besides the aforementioned information, the selection unit 12 may select the preliminary relay radio terminal in accordance with, for example, the communication quality or the radio quality of a cellular communication line in each of the radio terminals. For example, the radio terminal in which the communication quality or the radio quality of the cellular communication line is higher than a predetermined value may be selected as the preliminary relay radio terminal. Accordingly, when the main line is switched to the backup line, communication with excellent throughput and the like can be achieved.

Besides the aforementioned information, the selection unit 12 may select, for example, the preliminary relay radio terminal in accordance with a residual capacity of a battery in each of the radio terminals. The selection unit 12 may select, for example, a radio terminal whose residual capacity of the battery is larger than a predetermined capacity as the preliminary relay radio terminal.

Further, the selection unit 12 may select the preliminary relay radio terminal by combining positional information, information on the result of receiving the discovery signal, information regarding the reception power of the discovery signal, information regarding the number of radio terminals that are executing D2D communication, information regarding the communication quality of the cellular communication line, and information on the residual capacity of the battery.

Besides the aforementioned information, the selection unit 12 may select, for example, the preliminary relay radio terminal in accordance with the moving speed, the moving direction or the like of the radio terminal. The selection unit 12 may select, for example, a radio terminal that is moving in a direction different from that of the relay radio terminal as the preliminary relay radio terminal. It is therefore possible to configure the backup line little affected by the disconnection of the main line. Alternatively, the selection unit 12 may select a radio terminal whose moving speed is lower than a predetermined speed as the preliminary relay radio terminal. The selection unit 12 is therefore able to configure the backup line with a stable communication quality.

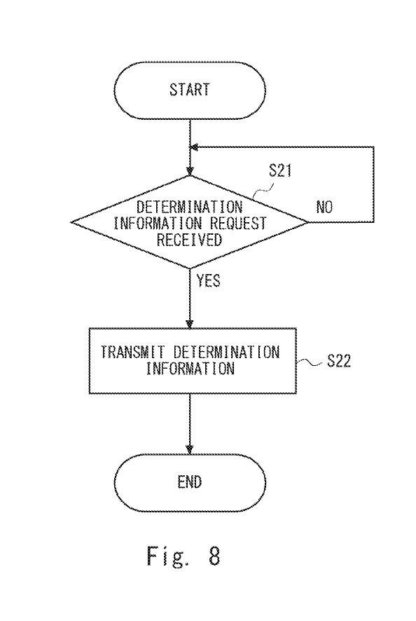

With reference next to FIG. 8, a flow of processing of transmitting the determination information in the radio terminal that may serve as the relay radio terminal or the preliminary relay radio terminal will be explained. In this example, the operations of the radio terminals 22-24 will be explained.

First, each of the radio terminals 22-24 determines whether it has received the determination information request from the radio terminal 21 (S21). The determination information request is a message or a signal to be used to request transmission of the determination information when the radio terminal 21 selects the preliminary relay radio terminal.

When it is determined that the determination information request has not been received, the radio terminals 22-24 repeat the processing of Step S21. When it is determined that the determination information request has been received, the radio terminals 22-24 transmit the determination information that they hold to the radio terminal 21 (S22).

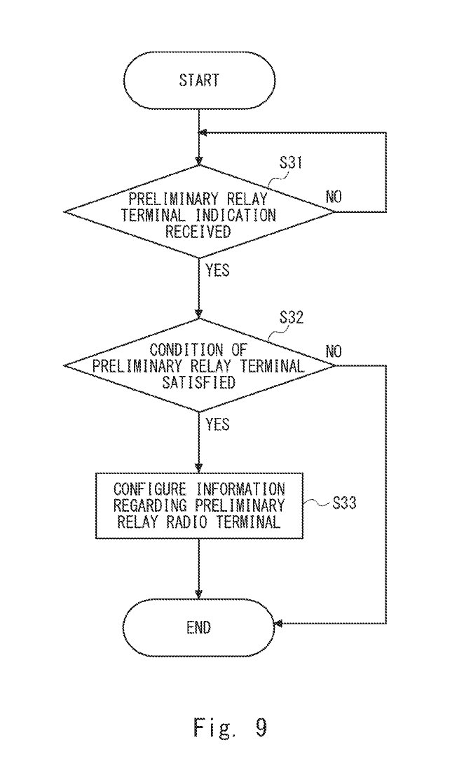

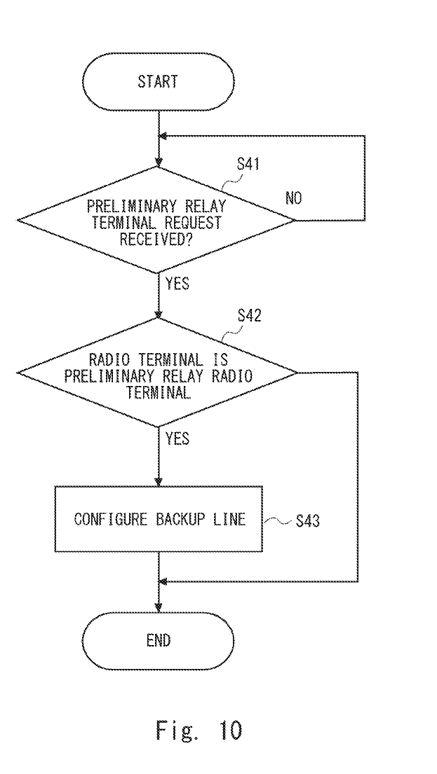

With reference next to FIG. 9, a flow of processing when the radio terminal 24 has received the preliminary relay terminal indication will be explained. First, the radio terminal 24 determines whether it has received the preliminary relay terminal indication (S31). When it is determined that the radio terminal 24 has not received the preliminary relay terminal indication, the processing of Step S31 is repeated.

When it is determined that the radio terminal 24 has received the preliminary relay terminal indication, the radio terminal 24 determines whether the radio terminal 24 satisfies a condition of the preliminary relay radio terminal. The condition of the preliminary relay radio terminal may be, for example, that the residual capacity of the battery is larger than a predetermined capacity, the number of backup lines that have been configured is smaller than a predetermined number, the number of main lines that have been configured is smaller than a predetermined number, or the cellular communication quality is better than a predetermined quality.

When it is determined that the radio terminal 24 does not satisfy the condition of the preliminary relay radio terminal, the radio terminal 24 ends the processing. That is, the radio terminal 24 does not configure the backup line between the radio terminal 24 and the radio terminal 21.

When it is determined that the radio terminal 24 satisfies the condition of the preliminary relay radio terminal, the radio terminal 24 configures the information for operating as the preliminary relay radio terminal (S33). The information for operating as the preliminary relay radio terminal may be, for example, identification information on the radio terminal 21 and further may be information that defines operations and the like when the radio terminal 24 has received a signal for requesting configuration of the backup line from the radio terminal 21.

Next, with reference to FIG. 10, a flow of processing of the radio terminal 24 when it has received the preliminary relay terminal request will be explained. The preliminary relay terminal request is the signal transmitted from the radio terminal 21 for requesting configuration of the backup line. Alternatively, the preliminary relay terminal request may be transmitted via the base station 40.

First, the radio terminal 24 determines whether it has received the preliminary relay terminal request transmitted from the radio terminal 21 (S41). When it is determined that the radio terminal 24 has not received the preliminary relay terminal request, the radio terminal 24 repeats the processing of Step S41.

When it is determined that the radio terminal 24 has received the preliminary relay terminal request, the radio terminal 24 determines whether it is the preliminary relay radio terminal (S42). In other words, the radio terminal 24 receives the preliminary relay terminal indication and determines whether it satisfies the condition of the preliminary relay radio terminal.

When it is determined that the radio terminal 24 is the preliminary relay radio terminal, the radio terminal 24 configures the backup line between the radio terminal 24 and the radio terminal 21 that has transmitted the preliminary relay terminal request (S43).

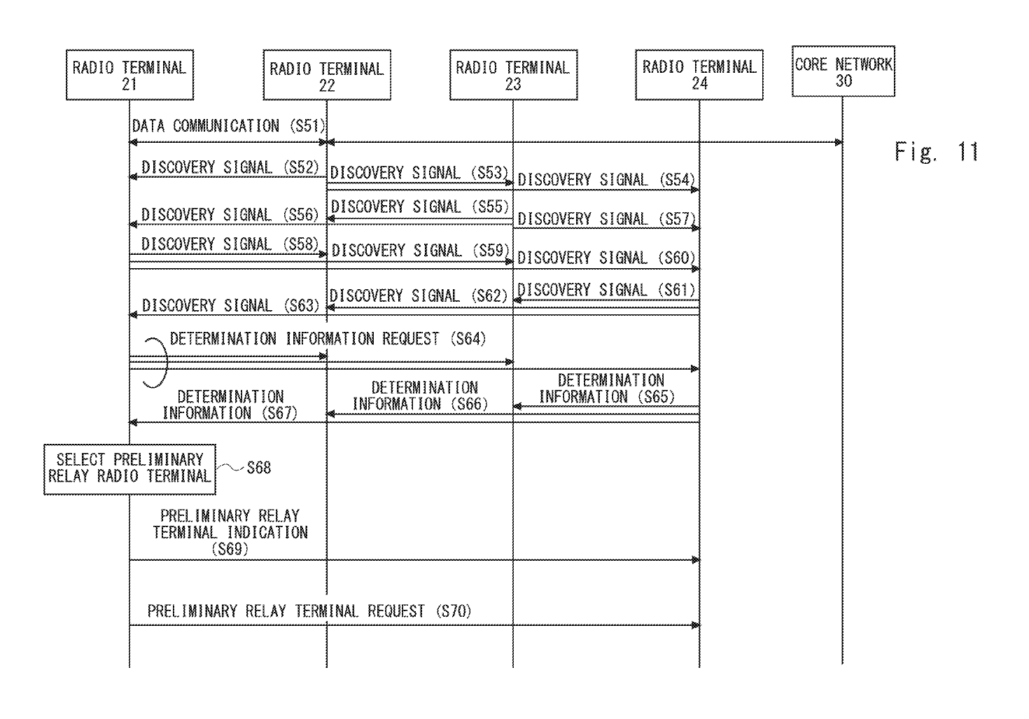

Next, with reference to FIG. 11, a sequence of processing for selecting the preliminary relay radio terminal according to the second embodiment of the present invention will be explained. First, it is assumed that the radio terminal 21 is performing D2D communication with the radio terminal 22 that operates as a relay radio terminal (S51). It is further assumed that the radio terminal 22 is performing cellular communication with the base station 40 and the core network 30.

Next, each of the radio terminals 21-24 transmits the discovery signal to the nearby radio terminals. Specifically, the radio terminal 22 transmits the discovery signal to the radio terminal 21, the radio terminal 23, and the radio terminal 24 in Steps S52 to S54. In a similar way, the radio terminal 23 transmits the discovery signal to the radio terminal 22, the radio terminal 21, and the radio terminal 24 in Steps S55 to S57. In a similar way, the radio terminal 21 transmits the discovery signal to the radio terminal 22, the radio terminal 23, and the radio terminal 24 in Steps S58 to S60. In a similar way, the radio terminal 24 transmits the discovery signal to the radio terminal 23, the radio terminal 22, and the radio terminal 21 in Steps S61 to S63.

While the discovery signal is transmitted to the radio terminal 22, the radio terminal 23, the radio terminal 21, and the radio terminal 24 in this order in Steps S52-S63, the order of transmitting the discovery signal is not limited to this order. Further, while the processing of specifying, by each of the radio terminals, the destination radio terminal and transmitting the discovery signal to this destination radio terminal has been described in Steps S52-S63, each of the radio terminals may collectively transmit the discovery signal to the nearby radio terminals by broadcasting.

Next, the radio terminal 21 transmits the determination information request to the radio terminals 22-24 in order to collect the determination information from the radio terminals 22-24 (S64).

Next, each of the radio terminals 22-24 transmits, upon receiving the determination information request, the determination information including the result of receiving the discovery signal or the positional information to the radio terminal 21 (S65-S67). Next, the radio terminal 21 selects the preliminary relay radio terminal using the determination information transmitted from each of the radio terminals 21-24 (S68). In this example, it is assumed that the radio terminal 21 has selected the radio terminal 24 as the preliminary relay radio terminal.

Next, the radio terminal 21 transmits the preliminary relay terminal indication to the radio terminal 24 in order to notify the radio terminal 24 of the preliminary relay radio terminal that has been selected (S69). Next, the radio terminal 21 transmits the preliminary relay terminal request to the radio terminal 24 in order to configure the backup line between the radio terminal 21 and the radio terminal 24 (S70).

In Step S70, the radio terminal 21 may transmit the preliminary relay terminal request to the nearby radio terminal by broadcasting in order to configure the backup line. At this time, the radio terminal 24 may execute the processing of configuring the radio line between the radio terminal 24 and the radio terminal 21 upon receiving the preliminary relay terminal request.

As described above, by using the communication system according to the second embodiment of the present invention, the radio terminal 21 is able to configure the backup line that is not affected by or little affected by the disconnection of the main line within the area in which D2D communication can be performed.

The radio terminal 21 is able to select, for example, a radio terminal which is located in a direction different from that of the relay radio terminal with respect to the radio terminal 21 as the preliminary relay radio terminal by selecting the preliminary relay radio terminal using the positional information on the radio terminal. It is therefore possible to reduce the probability that the cause of the disconnection of the main line between the radio terminal 21 and the relay radio terminal has an influence on the backup line.

Further, the radio terminal 21 is able to select a radio terminal that is located away from the relay radio terminal by a predetermined distance as the preliminary relay radio terminal by selecting the preliminary relay radio terminal using the result of receiving the discovery signal in the radio terminal. Further, since the radio terminal that is located away from the relay radio terminal with a shielding object such as a wall interposed therebetween cannot receive the discovery signal transmitted from the relay radio terminal, this radio terminal may be selected as the preliminary relay radio terminal. Accordingly, the radio terminal 21 is able to select the radio terminal having a radio environment different from a radio environment in a place where the relay radio terminal is present as the preliminary relay radio terminal. It is therefore possible to reduce the probability that the cause of the disconnection of the main line between the radio terminal 21 and the relay radio terminal has an influence on the backup line.

### Third Embodiment

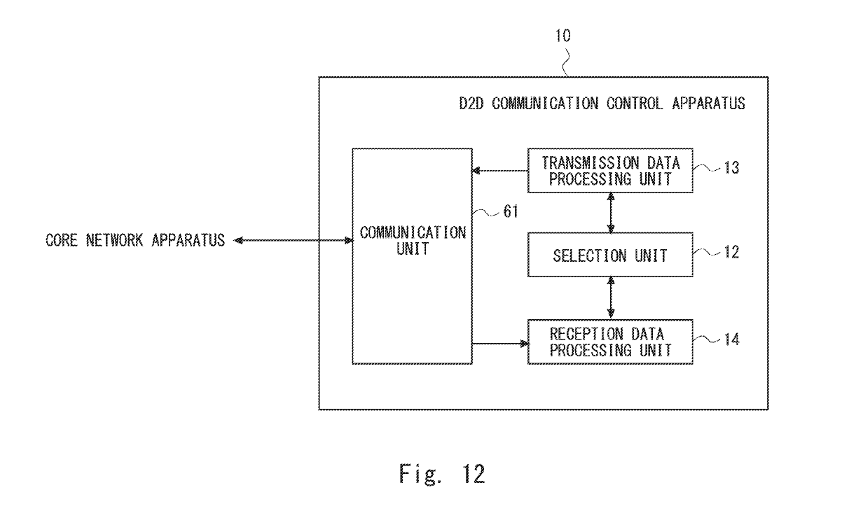

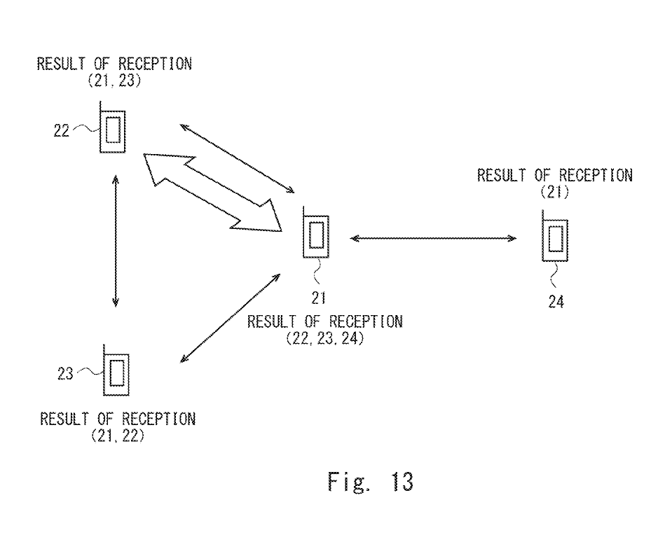

With reference next to FIG. 12, a configuration example of the D2D communication control apparatus 10 according to a third embodiment of the present invention will be explained. The D2D communication control apparatus 10 includes a communication unit 61, the selection unit 12, the transmission data processing unit 13, and the reception data processing unit 14. Since the selection unit 12, the transmission data processing unit 13, and the reception data processing unit 14 execute the functions or the processing similar to those of the selection unit 12, the transmission data processing unit 13, and the reception data processing unit 14 shown in FIG. 4, detailed descriptions thereof will be omitted.

The communication unit 61 communicates with the core network apparatus arranged in the core network 30. The reception data processing unit 14 receives the determination information transmitted from the radio terminals 21-24 via the communication unit 61. The reception data processing unit 14 outputs the determination information that has been received to the selection unit 12.

The selection unit 12 selects the preliminary relay radio terminal using the determination information received from the reception data processing unit 14. The transmission data processing unit 13 transmits, to the radio terminal that has been selected by the selection unit 12 to be the preliminary relay radio terminal, the preliminary relay terminal indication notifying that it is the preliminary relay radio terminal.

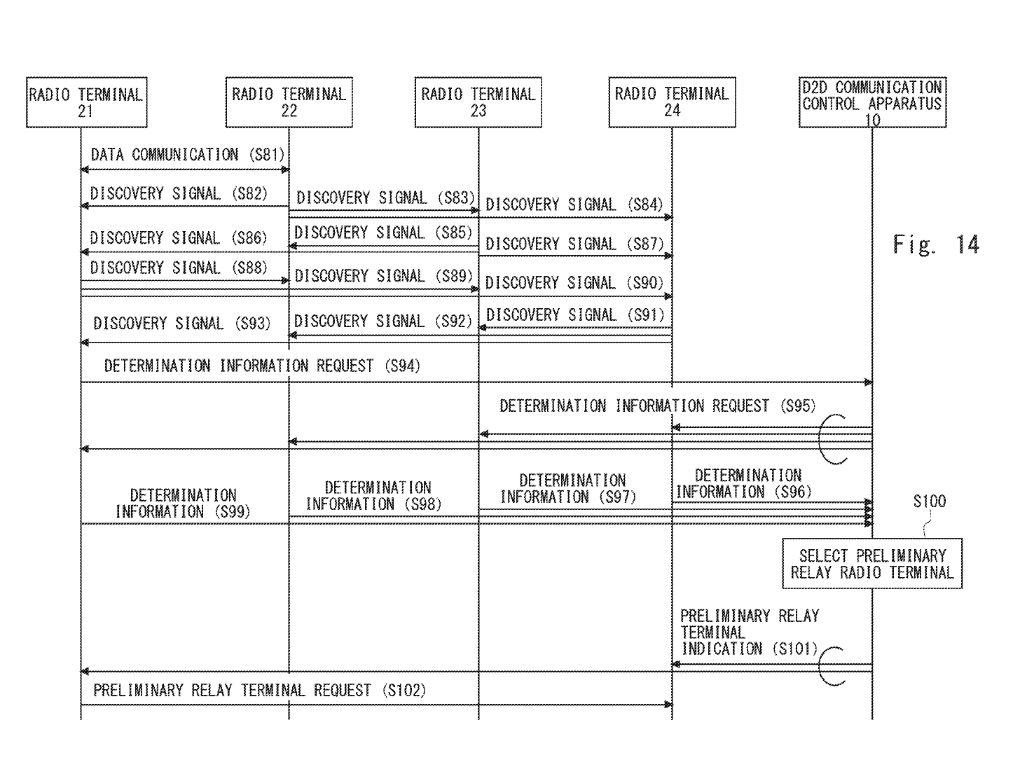

With reference next to FIG. 13, a case in which the reception data processing unit 14 receives the discovery signal including information regarding the result of the reception will be explained. While the radio terminals 22-24 transmit the information on the result of receiving the discovery signal to the radio terminal 21 in FIG. 7, the radio terminals 21-24 transmit the information on the result of receiving the discovery signal to the D2D communication control apparatus 10, not to the radio terminal 21, in FIG. 13.

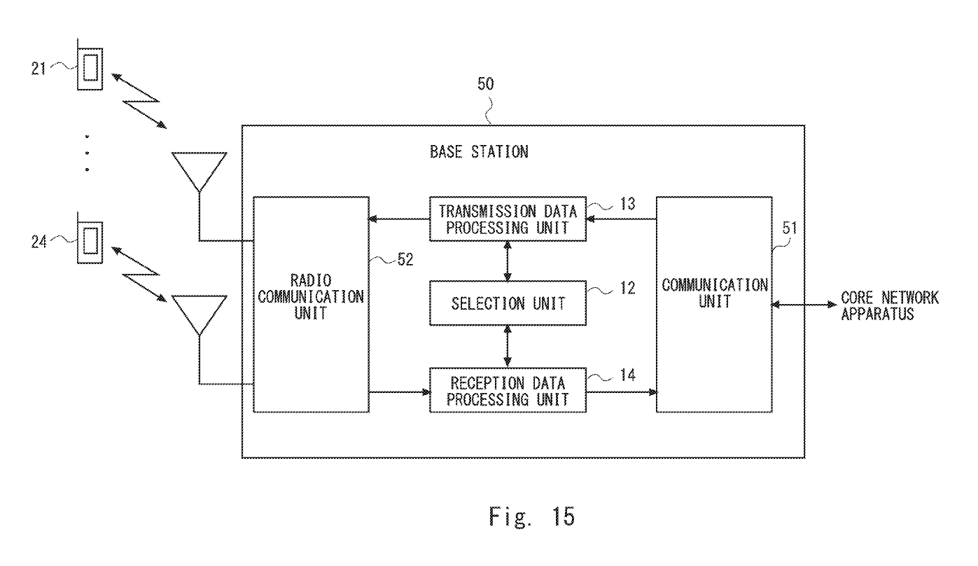

With reference next to FIG. 14, a sequence of processing of selecting the preliminary relay radio terminal according to the third embodiment of the present invention will be explained. Since Steps S81-S93 are similar to Steps S51-S63 in FIG. 11, detailed descriptions thereof will be omitted. The radio terminal 21 transmits the determination information request to the D2D communication control apparatus 10 in Step S94 in order to cause the D2D communication control apparatus 10 to collect the determination information (S94).

Next, the D2D communication control apparatus 10 transmits the determination information request to the radio terminals 21-24 in order to collect the determination information from the radio terminals 21-24 (S95).

Next, each of the radio terminals 21-24 transmits, upon receiving the determination information request, the determination information including the result of receiving the discovery signal or the positional information to the D2D communication control apparatus 10 (S96-S99). Next, the D2D communication control apparatus 10 selects the preliminary relay radio terminal using the determination information transmitted from each of the radio terminals 21-24 (S100). In this example, it is assumed that the D2D communication control apparatus 10 has selected the radio terminal 24 as the preliminary relay radio terminal.

Next, the D2D communication control apparatus 10 transmits the preliminary relay terminal indication to the radio terminal 24 and the radio terminal 21 in order to notify the radio terminal 24 and the radio terminal 21 of the preliminary relay radio terminal that has been selected (S101). Next, the radio terminal 21 transmits the preliminary relay terminal request to the radio terminal 24 in order to configure the backup line between the radio terminal 21 and the radio terminal 24 (S102).

While data transmission and reception are performed between the radio terminals 21-24 and the D2D communication control apparatus 10 via the base station 40 and the core network 30, the base station 40 and the core network 30 are not shown in FIG. 11.

Further, the D2D communication control apparatus 10 may autonomously or regularly transmit the determination information request to the radio terminals 21-24 in Step S95 without receiving the determination information request in Step S94.

Further, the D2D communication control apparatus 10 may transmit the preliminary relay terminal indication to only the radio terminal 24 that has been selected as the preliminary relay radio terminal in Step S101. In this case, the radio terminal 21 may transmit, for example, the preliminary relay terminal request to the nearby radio terminals by broadcasting in order to configure the backup line. At this time, the radio terminal 24 may execute processing of configuring the radio line between the radio terminal 24 and the radio terminal 21 upon receiving the preliminary relay terminal request.

As described above, by using the communication system according to the third embodiment of the present invention, the D2D communication control apparatus 10 is able to configure the backup line that is not affected by or little affected by the disconnection of the main line within the area in which D2D communication can be performed. By performing, by the D2D communication control apparatus 10, the processing of selecting the backup line, it is possible to reduce the processing load of the radio terminal compared to the case in which each of the radio terminals performs the selection processing.

### Fourth Embodiment

Next, with reference to FIG. 15, a configuration example of a base station 50 according to a third embodiment of the present invention will be explained. The base station 50 includes the selection unit 12, the transmission data processing unit 13, the reception data processing unit 14, a communication unit 51, and a radio communication unit 52. Since the selection unit 12, the transmission data processing unit 13, and the reception data processing unit 14 execute the functions or the processing similar to those of the selection unit 12, the transmission data processing unit 13, and the reception data processing unit 14 in FIG. 4, the detailed descriptions thereof will be omitted.

The communication unit 51 communicates with the core network apparatus arranged in the core network 30. The radio communication unit 52 performs radio communication with the radio terminals 21-24 and the like located in the cell that the base station 50 forms. The reception data processing unit 14 receives the determination information transmitted from the radio terminals 21-24 via the radio communication unit 52. The reception data processing unit 14 outputs the determination information that has been received to the selection unit 12.

The selection unit 12 selects the preliminary relay radio terminal using the determination information received from the reception data processing unit 14. The transmission data processing unit 13 transmits, to the radio terminal that has been selected by the selection unit 12 to be the preliminary relay radio terminal, the preliminary relay terminal indication that notifies that this radio terminal is the preliminary relay radio terminal.

As described above, the base station 50 includes the selection unit 12 included in the D2D communication control apparatus 10 in FIG. 12. Therefore, the base station 50 is able to select the preliminary relay radio terminal using the determination information transmitted from the radio terminals 21-24. Accordingly, the determination information and the relay terminal indication are not communicated between the base station 50 and the D2D communication control apparatus 10 any more or the amount of the determination information and the number of relay terminal indications to be communicated are reduced. It is therefore possible to reduce the amount of traffic in the core network 30.

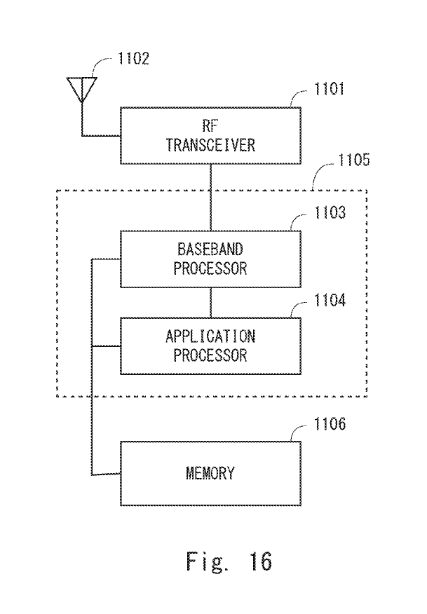

Lastly, configuration examples of the radio terminals 21-24, the base station 40, and the D2D communication control apparatus 10 according to the aforementioned embodiments will be explained. FIG. 16 is a block diagram showing a configuration example of the radio terminals 21-24. A Radio Frequency (RF) transceiver 1101 performs analog RF signal processing to communicate with the base station 40. The analog RF signal processing performed by the RF transceiver 1101 includes frequency up-conversion, frequency down-conversion, and amplification. The RF transceiver 1101 is coupled to an antenna 1102 and a baseband processor 1103. That is, the RF transceiver 1101 receives modulated symbol data (or OFDM symbol data) from the baseband processor 1103, generates a transmission RF signal, and supplies the transmission RF signal to the antenna 1102. Further, the RF transceiver 1101 generates a baseband reception signal based on a reception RF signal received by the antenna 1102, and supplies the baseband reception signal to the baseband processor 1103.

The baseband processor 1103 performs digital baseband signal processing (i.e., data plane processing) and control plane processing for radio communication. The digital baseband signal processing includes (a) data compression/decompression, (b) data segmentation/concatenation, (c) composition/decomposition of a transmission format (i.e., transmission frame), (d) channel coding/decoding, (e) modulation (i.e., symbol mapping)/demodulation, and (f) generation of OFDM symbol data (i.e., baseband OFDM signal) by Inverse Fast Fourier Transform (IFFT). On the other hand, the control plane processing includes communication management of layer 1 (e.g., transmission power control), layer 2 (e.g., radio resource management and hybrid automatic repeat request (HARQ) processing), and layer 3 (e.g., signalling regarding attach, mobility, and call management).

In the case of LTE and LTE-Advanced, the digital baseband signal processing performed by the baseband processor 1103 may include signal processing of a Packet Data Convergence Protocol (PDCP) layer, a Radio Link Control (RLC) layer, a MAC layer, and a PHY layer. Further, the control plane processing performed by the baseband processor 1103 may include processing of a Non-Access Stratum (NAS) protocol, an RRC protocol, and MAC CE.

The baseband processor 1103 may include a modem processor (e.g., a Digital Signal Processor (DSP)) that performs the digital baseband signal processing and a protocol stack processor (e.g., a Central Processing Unit (CPU) or a Micro Processing Unit (MPU)) that performs the control plane processing. In this case, the protocol stack processor, which performs control plane processing, may be integrated with an application processor 1104 described below.

The application processor 1104 is also referred to as a CPU, an MPU, a microprocessor, or a processor core. The application processor 1104 may include a plurality of processors (processor cores). The application processor 1104 loads a system software program (Operating System (OS)) and various application programs (e.g., a voice call application, a WEB browser, a mailer, a camera operation application, and a music player application) from a memory 1106 or from another memory (not shown) and executes these programs, thereby providing various functions of the radio terminal 21.

In some implementations, as represented by a dashed line (1105) in FIG. 16, the baseband processor 1103 and the application processor 1104 may be integrated on a single chip. In other words, the baseband processor 1103 and the application processor 1104 may be implemented in a single System on Chip (SoC) device 1105. An SoC device may be referred to as a system Large Scale Integration (LSI) or a chipset.

The memory 1106 is a volatile memory, a non-volatile memory, or a combination thereof. The memory 1106 may include a plurality of memory devices that are physically independent from each other. The volatile memory is, for example, a Static Random Access Memory (SRAM), a Dynamic RAM (DRAM), or a combination thereof. The non-volatile memory is, for example, a mask Read Only Memory (MROM), an Electrically Erasable Programmable ROM (EEPROM), a flash memory, a hard disc drive, or any combination thereof. The memory 1106 may include, for example, an external memory device that can be accessed from the baseband processor 1103, the application processor 1104, and the SoC 1105. The memory 1106 may include, for example, an internal memory device that is integrated in the baseband processor 1103, the application processor 1104, or the SoC 1105. Further, the memory 1106 may include a memory in a Universal Integrated Circuit Card (UICC).

The memory 1106 may store software modules (computer programs) including instructions and data for performing the processing by the radio terminal 21 described in the aforementioned embodiments. In some implementations, the baseband processor 1103 or the application processor 1104 may load the software modules from the memory 1106 and execute these loaded software modules, thereby performing the processing of the radio terminal 21 described with reference to the sequence diagrams and the flowcharts in the aforementioned embodiments.

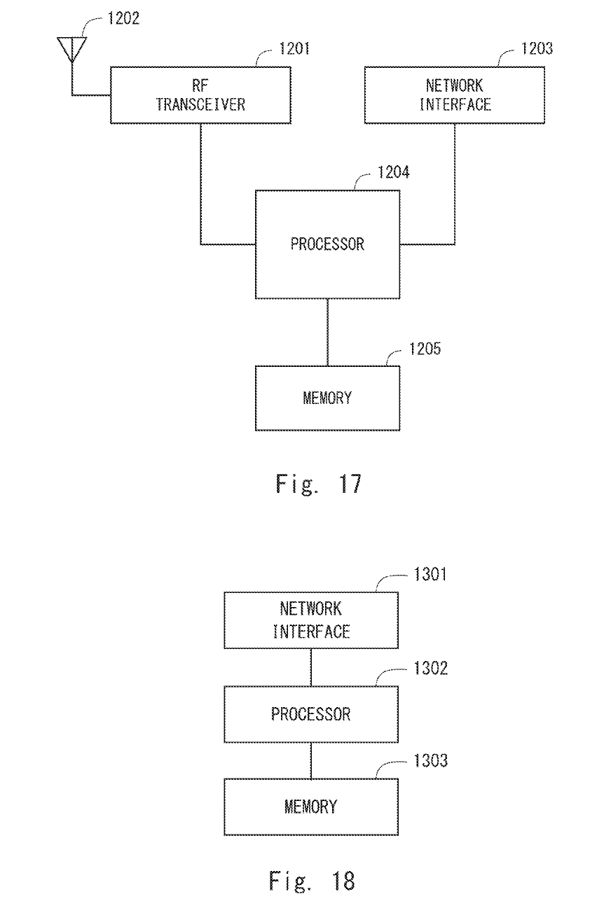

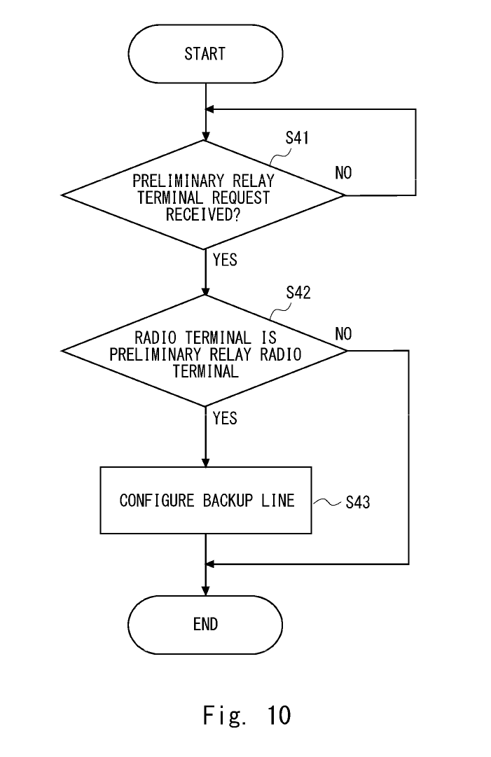

FIG. 17 is a block diagram showing a configuration example of the base station 40 according to the aforementioned embodiments. Referring to FIG. 17, the base station 40 includes an RF transceiver 1201, a network interface 1203, a processor 1204, and a memory 1205. The RF transceiver 1201 performs analog RF signal processing in order to communicate with the radio terminal 21. The RF transceiver 1201 may include a plurality of transceivers. The RF transceiver 1201 is coupled to an antenna 1202 and the processor 1204. The RF transceiver 1201 receives modulated symbol data (or OFDM symbol data) from the processor 1204, generates a transmission RF signal, and supplies the transmission RF signal to the antenna 1202. Further, the RF transceiver 1201 generates a baseband reception signal based on a reception RF signal received by the antenna 1202, and supplies the baseband reception signal to the processor 1204.

The network interface 1203 is used to communicate with a network node (e.g., Mobility Management Entity (MME) and a Serving Gateway (S-GW)). The network interface 1203 may include, for example, a network interface card (NIC) conforming to the IEEE 802.3 series.

The processor 1204 performs digital baseband signal processing (data plane processing) and control plane processing for radio communication. In the case of LTE and LTE-Advanced, for example, the digital baseband signal processing performed by the processor 1204 may include signal processing of the PDCP layer, the RLC layer, the MAC layer, and the PHY layer. Further, the control plane processing performed by the processor 1204 may include processing of the S1 protocol, the RRC protocol, and MAC CE.

The processor 1204 may include a plurality of processors. The processor 1204 may include, for example, a modem processor (e.g., a DSP) that performs the digital baseband signal processing and a protocol stack processor (e.g., a CPU or an MPU) that performs the control plane processing.

The memory 1205 is composed of a combination of a volatile memory and a non-volatile memory. The volatile memory is, for example, an SRAM, a DRAM, or a combination thereof. The non-volatile memory is, for example, an MROM, a PROM, a flash memory, a hard disc drive, or a combination thereof. The memory 1205 may include a storage that is spaced apart from the processor 1204. In this case, the processor 1204 may access the memory 1205 via the network interface 1203 or an I/O interface (not shown).

The memory 1205 may store software modules (computer programs) including instructions and data for performing processing by the base station 40 described in the aforementioned embodiments. In some implementations, the processor 1204 may load these software modules from the memory 1205 and execute these loaded software modules, thereby performing processing of the base station 40 described with reference to the sequence diagrams and the flowcharts in the aforementioned embodiments.

FIG. 18 is a block diagram showing a configuration example of the D2D communication control apparatus 10 according to the aforementioned embodiments. Referring to FIG. 18, the D2D communication control apparatus 10 includes a network interface 1301, a processor 1302, and a memory 1303. The network interface 1301 is used to communicate with the radio terminal 21. The network interface 1301 may include, for example, a network interface card (NIC) conforming to the IEEE 802.3 series.

The processor 1302 loads software (computer program) from the memory 1303 and executes the loaded software, thereby performing the processing of the D2D communication control apparatus 10 described with reference to the sequence diagrams and flowcharts in the aforementioned embodiments. The processor 1302 may include, for example, a microprocessor, an MPU, or a CPU. The processor 1302 may include a plurality of processors.

The memory 1303 is composed of a combination of a volatile memory and a non-volatile memory. The memory 1303 may include a storage spaced apart from the processor 1302. In this case, the processor 1302 may access the memory 1303 via an I/O interface (not shown).

In the example shown in FIG. 18, the memory 1303 is used to store software modules including a control module for D2D communication. The processor 1302 loads these software modules from the memory 1303 and executes these loaded software modules, thereby performing the processing of the D2D communication control apparatus 10 described in the aforementioned embodiments.

As described above with reference to FIGS. 16 to 18, each of the processors included in the radio terminals 21-24, the base station 40, and the D2D communication control apparatus 10 according to the aforementioned embodiments executes one or more programs including instructions to cause a computer to perform an algorithm described with reference to the drawings. The program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Further, the aforementioned embodiments may be executed independently from each other or may be combined with each other as appropriate.

Note that the present invention is not limited to the aforementioned embodiments and may be changed as appropriate without departing from the spirit of the present invention.

While the present invention has been described above with reference to the embodiments, the present invention is not limited to the aforementioned embodiments. Various changes that may be understood by those skilled in the art within the scope of the invention may be made to the configurations and the details of the present invention.

This application is based upon and claims the benefit of priority from Japanese Patent Application No. 2015-127782, filed on Jun. 25, 2015, the disclosure of which is incorporated herein in its entirety by reference.

### REFERENCE SIGNS LIST

1 NETWORK
10 D2D COMMUNICATION CONTROL APPARATUS
11 COMMUNICATION UNIT
12 SELECTION UNIT
13 TRANSMISSION DATA PROCESSING UNIT
14 RECEPTION DATA PROCESSING UNIT
21 RADIO TERMINAL
22 RADIO TERMINAL
23 RADIO TERMINAL
24 RADIO TERMINAL
30 CORE NETWORK
40 BASE STATION
41 CELL
42 COVERAGE HOLE
50 BASE STATION
51 COMMUNICATION UNIT
52 RADIO COMMUNICATION UNIT
60 RADIO TERMINAL
61 COMMUNICATION UNIT
65 RADIO TERMINAL
70 BASE STATION
80 APPLICATION SERVER

1. A radio terminal comprising:
at least one memory storing instructions, and
at least one processor configured to execute the instructions to;
receive determination information that can be used to determine whether each of a plurality of other radio terminals is capable of performing device-to-device (D2D) communication with another radio terminal; and
select, in a situation in which D2D communication is being performed with a relay radio terminal that performs cellular communication with a network, a radio terminal in which the determination information between the radio terminal and the relay radio terminal satisfies a predetermined condition among radio terminals that are capable of performing D2D communication, as a preliminary relay radio terminal.

2. The radio terminal according to claim 1, wherein the determination information comprises at least one of positional information generated by each of the plurality of other radio terminals and reception result information indicating a result of receiving a discovery signal that each of the plurality of radio terminals has transmitted to or received from a nearby radio terminal.

3. The radio terminal according to claim 2, wherein the at least one processor is further configured to execute the instructions to select, when receiving the positional information as the determination information, a radio terminal that is located at a distance in which it can perform D2D communication and is located in a direction different from that of the relay radio terminal as the preliminary relay radio terminal.

4. The radio terminal according to claim 3, wherein the at least one processor is further configured to execute the instructions to select the preliminary relay radio terminal in such a way that, when receiving the positional information as the determination information, a first distance between the radio terminal and the relay radio terminal, a second distance between the radio terminal and the preliminary relay radio terminal, and a third distance between the relay radio terminal and the preliminary relay radio terminal satisfy a relation that the third distance is equal to or larger than the first distance and the third distance is equal to or larger than the second distance.

5. The radio terminal according to claim 2, wherein the reception result information comprises identification information on a radio terminal that has transmitted a discovery signal that each of the plurality of radio terminals has received.

6. The radio terminal according to claim 5, wherein the at least one processor is further configured to execute the instructions to select, when receiving the reception result information as the determination information, a radio terminal that does not include identification information on the relay radio terminal in the reception result information among radio terminals that include identification information on the radio terminal in the reception result information as the preliminary relay radio terminal.

7. The radio terminal according to claim 6, wherein the at least one processor is further configured to execute the instructions to select the preliminary relay radio terminal using at least one of the reception power of the discovery signal, the number of times the discovery signal has been received, the number of radio terminals that are executing D2D communication, communication quality of a cellular communication line, a residual capacity of a battery, a moving direction, and a moving speed when there are a plurality of radio terminals that do not include identification information on the relay radio terminal in the reception result information, or when there is no radio terminal that does not include identification information on the relay radio terminal in the reception result information among radio terminals that include identification information on the radio terminal in the reception result information.

8. The radio terminal according to claim 7, wherein the at least one processor is further configured to execute the instructions to select, when there are a plurality of radio terminals that do not include identification information on the relay radio terminal in the reception result information among radio terminals that include identification information on the radio terminal in the reception result information, a radio terminal in which the reception power of the discovery signal transmitted from the radio terminal is equal to or larger than a threshold as the relay radio terminal.

9. The radio terminal according to claim 7, wherein the at least one processor is further configured to execute the instructions to select, when there are a plurality of radio terminals that do not include identification information on the relay radio terminal in the reception result information among radio terminals that include identification information on the radio terminal in the reception result information, a radio terminal in which the reception power of the discovery signal transmitted from the radio terminal is the largest as the relay radio terminal.

10. The radio terminal according to claim 7, wherein the at least one processor is further configured to execute the instructions to select, when there is no radio terminal that does not include identification information on the relay radio terminal in the reception result information among radio terminals that include identification information on the radio terminal in the reception result information, a radio terminal in which the reception power of the discovery signal transmitted from the relay radio terminal is equal to or smaller than a threshold as the relay radio terminal.

11. The radio terminal according to claim 7, wherein the at least one processor is further configured to execute the instructions to select, when there is no radio terminal that does not include identification information on the relay radio terminal in the reception result information among radio terminals that include identification information on the radio terminal in the reception result information, a radio terminal in which the reception power of the discovery signal transmitted from the relay radio terminal is the smallest as the relay radio terminal.

12. (canceled)

13. (canceled)

14. (canceled)

15. (canceled)

16. A D2D communication control apparatus comprising:
at least one memory storing instructions, and
at least one processor configured to execute the instructions to;
receive determination information that can be used to determine whether a plurality of radio terminals are capable of performing direct communication (device-to-device (D2D) communication) with another radio terminal; and
select, in a situation in which a first radio terminal included in the plurality of radio terminals is performing D2D communication with a relay radio terminal that performs cellular communication with a network, a radio terminal in which the determination information between the radio terminal and the relay radio terminal satisfies a predetermined condition among radio terminals capable of performing D2D communication with the first radio terminal, as a preliminary relay radio terminal.

17. The D2D communication control apparatus according to claim 16, wherein the determination information comprises at least one of positional information generated by each of the plurality of radio terminals and reception result information indicating a result of receiving a discovery signal that each of the plurality of radio terminals has transmitted to or received from a nearby radio terminal.

18. The D2D communication control apparatus according to claim 17, wherein the at least one processor is further configured to execute the instructions to select, when receiving the positional information as the determination information, a radio terminal that is located at a distance in which it can perform D2D communication with the first radio terminal and is further located in a direction different from that of the relay radio terminal with respect to the first radio terminal as the preliminary relay radio terminal.

19. The D2D communication control apparatus according to claim 17, wherein the at least one processor is further configured to execute the instructions to select the preliminary relay radio terminal in such a way that, when receiving the positional information as the determination information, a first distance between the first radio terminal and the relay radio terminal, a second distance between the first radio terminal and the preliminary relay radio terminal, and a third distance between the relay radio terminal and the preliminary relay radio terminal satisfy a relation that the third distance is equal to or larger than the first distance and the third distance is equal to or larger than the second distance.

20. The D2D communication control apparatus according to claim 17, wherein the reception result information comprises identification information on a radio terminal that has transmitted a discovery signal that each of the plurality of radio terminals has received.

21. The D2D communication control apparatus according to claim 20, wherein, when the receiving the reception result information as the determination information, the at least one processor is further configured to execute the instructions to select a radio terminal that does not include identification information on the relay radio terminal in the reception result information among radio terminals that include identification information on the first radio terminal in the reception result information as the preliminary relay radio terminal of the first radio terminal.

22. The D2D communication control apparatus according to claim 21, wherein the at least one processor is further configured to execute the instructions to select the preliminary relay radio terminal using at least one of the reception power of the discovery signal, the number of times the discovery signal has been received, the number of radio terminals that are executing D2D communication, communication quality of a cellular communication line, a residual capacity of a battery, a moving direction, and a moving speed when there are a plurality of radio terminals that do not include identification information on the relay radio terminal in the reception result information, or when there is no radio terminal that does not include identification information on the relay radio terminal in the reception result information among radio terminals including identification information on the first radio terminal in the reception result information.

23. The D2D communication control apparatus according to claim 22, wherein the at least one processor is further configured to execute the instructions to select, when there are a plurality of radio terminals that do not include identification information on the relay radio terminal in the reception result information among radio terminals including identification information on the first radio terminal in the reception result information, a radio terminal in which the reception power of the discovery signal transmitted from the first radio terminal is equal to or larger than a threshold as the relay radio terminal.

24. (canceled)

25. (canceled)

26. (canceled)

27. (canceled)

28. (canceled)

29. (canceled)

30. (canceled)

31. A preliminary relay radio terminal selection method comprising:
receiving determination information that can be used to determine whether a plurality of radio terminals are capable of performing device-to-device (D2D) communication with another terminal; and
selecting, in a situation in which a first radio terminal included in the plurality of radio terminals is performing D2D communication with a relay radio terminal that performs cellular communication with a network, a radio terminal in which the determination information between the radio terminal and the relay radio terminal satisfies a predetermined condition among radio terminals capable of performing D2D communication with the first radio terminal, as a preliminary relay radio terminal.

32. (canceled)
